(19) United States
(12) Patent Application Publication
(10) Pub. No.: US 2026/0161409 A1
(43) Pub. Date: Jun. 11, 2026

(54) BRANCH HISTORY BASED INSTRUCTION PREFETCHING

(71) Applicant: Intel Corporation, Santa Clara, CA (US)

(72) Inventors: Ankur Groen, San Jose, CA (US); Ammon J. Christiansen, Warren, OR (US); Muawya M. Al-Otoom, Beaverton, OR (US)

(73) Assignee: Intel Corporation, Santa Clara, CA (US)

(21) Appl. No.: 18/969,890

(22) Filed: Dec. 5, 2024

(51) Int. Cl. G06F 9/38; G06F 9/30

(52) U.S. Cl. CPC G06F 9/3806; G06F 9/30058

(57) ABSTRACT

Methods and apparatus relating to branch history based instruction prefetching are described. In an embodiment, a Prefetch Miss Table (PMT) stores information corresponding to a history of one or more branches. Logic circuitry in a processor causes storage of the information in the PMT based at least in part on one or more hits in an instruction cache due to one or more previous prefetch operations for the one or more branches. Upon a hit in the PMT, one or more prefetch requests are sent for the one or more branches to the instruction cache. Other embodiments are also disclosed and claimed.

### FIELD OF THE INVENTION

The present disclosure generally relates to the field of processors. More particularly, some embodiments relate to branch history based instruction prefetching.

### BACKGROUND OF THE INVENTION

To improve performance, some processors prefetch an instruction into an instruction cache (called an “iCache” or “ICache”). Generally, information stored in a cache may be accessed more quickly than information stored in, for example, a main system memory. Prefetching instructions into an ICache before they are specifically requested or need to be executed reduces the latency and improves performance.

### BRIEF DESCRIPTION OF DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of an instruction prefetcher, according to an embodiment.

FIG. 2 illustrates a data flow diagram for a prefetcher, according to an embodiment.

FIG. 3 illustrates an example computing system.

FIG. 4 illustrates a block diagram of an example processor and/or System on a Chip (SoC) that may have one or more cores and an integrated memory controller.

FIG. 5(A) is a block diagram illustrating both an example in-order pipeline and an example register renaming, out-of-order issue/execution pipeline according to examples.

FIG. 5(B) is a block diagram illustrating both an example in-order architecture core and an example register renaming, out-of-order issue/execution architecture core to be included in a processor according to examples.

FIG. 6 illustrates examples of execution unit(s) circuitry.

### DETAILED DESCRIPTION OF THE INVENTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, prefetching instructions into an ICache before they are specifically requested or need to be executed reduces the latency and improves performance. Furthermore, Large Code Footprint (LCF) traces face ICache (also interchangeably referred to as “I$” herein) miss as a bottleneck in top-down analysis.

To this end, some embodiments provide branch history based instruction prefetching. In an embodiment, a pattern-based hardware ICache (e.g., utilizing a prefetch miss table) is used for prefetching instructions. Such a pattern-based hardware instruction prefetcher may help prevent code misses on LCF applications. Also, such an instruction prefetcher may hide the Level 2(L2) cache miss latency on code which is too large to fit in the Level 1 (L1) cache and potentially larger than the branch predictor history.

In one embodiment, a pattern-based hardware ICache prefetcher can reduce the ICache miss penalty by prefetching critical cachelines. Since an embodiment utilizes a hardware prefetcher, no software needs to be re-compiled with prefetch hints. In some embodiments, post Silicon (SI) (i.e., after semiconductor manufacturing) tunable knobs or control register settings may be provided, which allow for easy adjustment, e.g., based on the System On Chip (SOC) in which the Central Processing Unit (CPU) is included with the ICache.

Moreover, future workloads are expected to have larger and larger code footprints; it is expected that a Branch Prediction Unit (BPU) and ICache cannot be scaled to capture the increasing number of cachelines. However, LCF traces tend to have a predictable control flow, and so some embodiments attempt to capture the critical misses and prefetch them to reduce the bottleneck associated with ICache miss penalty.

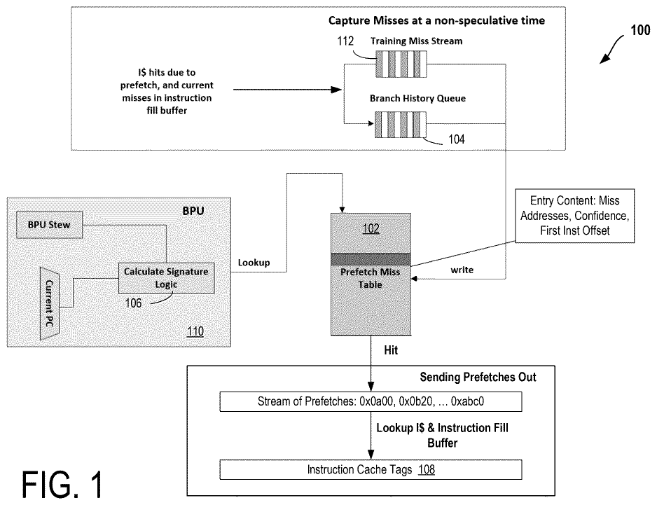

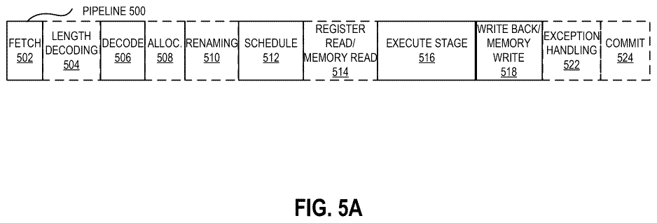

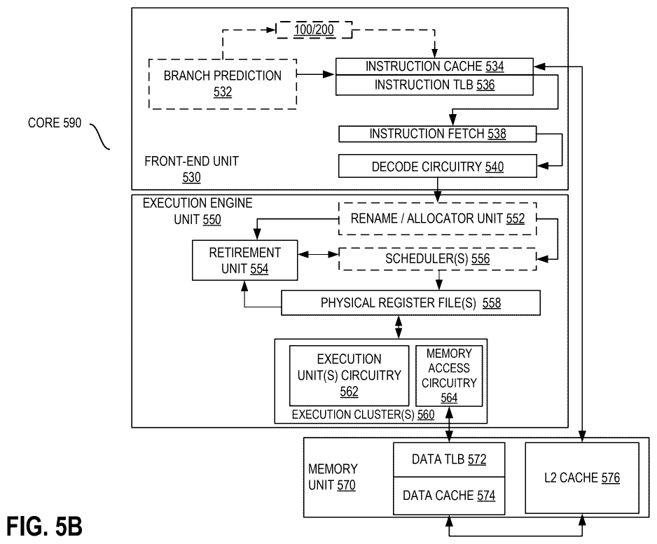

FIG. 1 illustrates a block diagram of an instruction prefetcher 100, according to an embodiment. In one embodiment, one or more components of FIG. 1 are also shown and discussed with reference to FIG. 5B.

Referring to FIG. 1, a Prefetch Miss Table (PMT) 102 may be a multi-level table which stores, for a given branch history, which prefetches should be issued. In an embodiment, the miss in the upper table is considered and used to generate prefetches. Each table may use a different number of branch history bits (e.g., hashed with the current Linear-address Instruction Pointer (LIP)) in one embodiment. The lower table may use only a few branch history bits and the upper table may use many more history bits. Each entry in the PMT table may have some maximum number of prefetches which a signature may issue. Each prefetch address may also have a confidence counter which indicates whether the prefetch should be issued. Accordingly, the entry content for the PMT 102 may include one or more miss addresses, the confidence counter, and first instruction offset per miss address.

A Branch History Queue (BHQ) 104 keeps track of the history of branches. In one embodiment, BHQ stores the hashed value of the branch history register, and not the full value. This allows for reduction of history data that need to be stored with incremental branch changes. In an embodiment, it is also possible to track misses at a more coarse granularity, e.g., excluding potentially too much detail from local control flow branches. In an embodiment, BHQ stores the hashed value in order from oldest to youngest. BHQ allows for issuing a prefetch at some distance earlier than when occurrence of a corresponding miss. This distance may be determined based on the SOC the CPU is in (because is it related to the L2 miss latency in the SoC/system), and so is left configurable for post silicon tunability. In an embodiment, the PMT keeps track of the prefetches to fetch based off a particular signature (e.g., calculated by logic 106). There may also be a signature history queue to adjust the prefetch distance.

To aid training, a prefetch bit (p-bit) will be added to the ICache tag 108. It marks if a cacheline has been filled due to a prefetch request. Once the cacheline is accessed by a demand request (e.g., generated by the BPU 110), the p-bit is cleared. This allows for training new misses and may be used to determine when prefetching is helping prevent ICache misses. As shown in FIG. 1, I$ hits due to prior prefetches and current I$ misses for all cache lines in the prediction block are tracked by the BHQ 104 and a training miss queue 112 (e.g., captured speculatively but trained at a non-speculative time such as retirement). This information is used to write to the PMT 102. The BPU 110 may then look up information from the PMT 102 as discussed herein and upon a hit in the PMT 102, prefetch requests are sent out. It is valuable to include not just I$ misses but I$ hits based on prefetched data to ensure that when the BPU sends us to the same cache lines in the future that we also have the previously prefetched lines.

BPU also includes a BPU stew which refers various internal logic used by BPU. Logic 106 is triggered per the current program counter (PC).

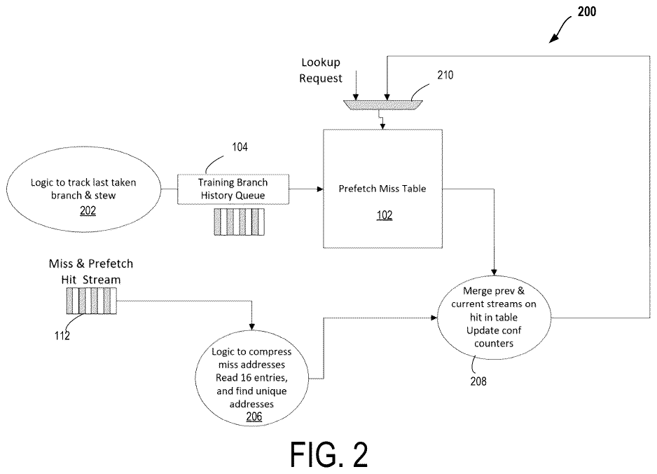

FIG. 2 illustrates a data flow diagram for a prefetcher 200, according to an embodiment. In one embodiment, one or more components of FIG. 2 are also shown and discussed with reference to FIG. 5B.

Referring to FIGS. 1-2, a training miss queue 112 (e.g., First In, First Out (FIFO)) is used to store information to train the PMT 102. In an embodiment, the misses being sent to L2 from the ICache may be tracked (e.g., periodically captured). All demand misses and ICache hits which were prefetched go into this queue 112. In one embodiment, at certain types of branches, all misses may be stored in this queue to train them for a branch history. Even though some embodiments may observe the miss at a branch history of X, this information is inserted into the tables at a distance (D) of X-D which may be determined by reading the Branch History Queue 104. The distance D allows the prefetch request to be sent to L2 early enough that the I$ can be pre-filled before the miss would occur (and the L2 latency would be exposed and reduce performance). Also. the prefetcher may have many post-SI tunable knobs so that the prefetcher can be tuned for different SOCs.

Logic 202 tracks last taken branch target and branch history (a mixture called stew) and causes this information to be stored in the BHQ 104 for writing to PMT 102. Miss and prefetch hit stream queue 112 may provide information to logic 206 to compress miss addresses (e.g., by reading entries in queue 112 (for example, 16 entries at a time) and finding unique addresses). Logic 208 merges previous and current streams on a hit in the PMT 102 and from logic 206, respectively, to update the confidence counter. A multiplexer 210 then allows for the information from logic 208 and a look up request to be selectively issued to the PMT 102.

In turn, the prefetcher is trained by looking up the Prefetch Miss Table 102 with the stew D predictions ago. If there is a hit for the lookup stew in the Prefetch Miss Table(s), then it can be determined if these prefetch addresses were seen before. If so, then the confidence counter is incremented. If not, then insert or replace low confidence prefetches with the new prefetch addresses. This approach updates the miss stream.

In some embodiments, a new history is not captured in the branch history queue 104 for every branch. Instead, the new history is captured for all unconditional branches along with call procedures and returns. This allows the prefetcher to focus on global, unconditional control flow.

In some embodiments, the following stream update algorithm may be used:
By default the new_miss_stream=previous_miss_stream.
If a line exists in previous_miss_stream & current_miss_stream, increment the confidence counter.
If a line exists only in the previous_miss_stream &! current_miss_stream, decrement the confidence counter.
For lines which only exist in the current_miss_stream, try and insert them into new_miss_stream.
If there is still space to add more cachelines to the new_miss_stream, then just add the new lines. However, if not all the new lines from current miss stream can fit, then look for candidates to evict, and replace the old lines.
If a cacheline in the previous_miss_stream has a confidence below a configurable watermark (threshold), it can be replaced with a new miss line.
When a new miss line is inserted into the miss_stream, the initial value of its confidence=init_confidence.

Another post silicon knob is the ability to lock lines. Since there may only be a small number of confidence bits per cacheline in a stream, we want to limit how often prefetching lines go between saturated and unsaturated. This introduces the concept of locked lines. Once a line is saturated, it can be marked as locked. This means it cannot be decremented, and that we will have consistent prefetches going out for a particular branch history. This needs to be used with care though, since it can lead to problems where new miss lines cannot be allocated.

A miss line cannot be allocated if all the misses in that entry are saturated (already have a high confidence) or locked. If a miss line cannot be allocated, then the global allocate counter is incremented. When the global allocate counter meets its threshold, all saturated prefetch confidence counters are decremented to a watermark value. If locking is enabled, then first a line gets unlocked, and then the next time we will decrement the counter values. Unlocking is a pre-step to decrementing the confidence counter and is meant to provide additional resistance to replacement to ensure that we are not overly aggressive to replace something. This provides mode stability in prefetches, and ensures that we are sure that we want to change a stream before kicking out stable prefetches.

In some implementations, misses may be tracked at retirement (which requires piping the miss information all the way through the retirement stage or having some processor Front End (FE) queue which keeps this status per cacheline until instructions retire). This can create a large overhead. By contrast, in some embodiments, by tracking misses in the FE, the training process is simplified, making it a buildable design. The trigger point including unconditional branches also allow for breaking down the miss streams into smaller units.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

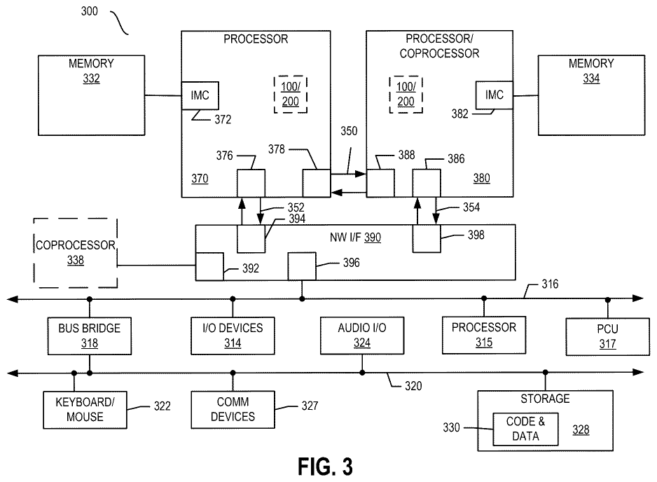

FIG. 3 illustrates an example computing system. Multiprocessor system 300 is an interfaced system and includes a plurality of processors or cores including a first processor 370 and a second processor 380 coupled via an interface 350 such as a point-to-point (P-P) interconnect, a fabric, and/or bus. In some examples, the first processor 370 and the second processor 380 are homogeneous. In some examples, first processor 370 and the second processor 380 are heterogenous. Though the example system 300 is shown to have two processors, the system may have three or more processors, or may be a single processor system. In some examples, the computing system is a system on a chip (SoC).

Processors 370 and 380 are shown including integrated memory controller (IMC) circuitry 372 and 382, respectively. Processor 370 also includes interface circuits 376 and 378; similarly, second processor 380 includes interface circuits 386 and 388. Processors 370, 380 may exchange information via the interface 350 using interface circuits 378, 388. IMCs 372 and 382 couple the processors 370, 380 to respective memories, namely a memory 332 and a memory 334, which may be portions of main memory locally attached to the respective processors.

Processors 370, 380 may each exchange information with a network interface (NW I/F) 390 via individual interfaces 352, 354 using interface circuits 376, 394, 386, 398. The network interface 390 (e.g., one or more of an interconnect, bus, and/or fabric, and in some examples is a chipset) may optionally exchange information with a coprocessor 338 via an interface circuit 392. In some examples, the coprocessor 338 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 370, 380 or outside of both processors, yet connected with the processors via an interface such as P-P interconnect, such that either or both processors'local cache information may be stored in the shared cache if a processor is placed into a low power mode.

Network interface 390 may be coupled to a first interface 316 via interface circuit 396. In some examples, first interface 316 may be an interface such as a Peripheral Component Interconnect (PCI) interconnect, a PCI Express interconnect or another I/O interconnect. In some examples, first interface 316 is coupled to a power control unit (PCU) 317, which may include circuitry, software, and/or firmware to perform power management operations with regard to the processors 370, 380 and/or co-processor 338. PCU 317 provides control information to a voltage regulator (not shown) to cause the voltage regulator to generate the appropriate regulated voltage. PCU 317 also provides control information to control the operating voltage generated. In various examples, PCU 317 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 317 is illustrated as being present as logic separate from the processor 370 and/or processor 380. In other cases, PCU 317 may execute on a given one or more of cores (not shown) of processor 370 or 380. In some cases, PCU 317 may be implemented as a microcontroller (dedicated or general-purpose) or other control logic configured to execute its own dedicated power management code, sometimes referred to as P-code. In yet other examples, power management operations to be performed by PCU 317 may be implemented externally to a processor, such as by way of a separate power management integrated circuit (PMIC) or another component external to the processor. In yet other examples, power management operations to be performed by PCU 317 may be implemented within BIOS or other system software.

Various I/O devices 314 may be coupled to first interface 316, along with a bus bridge 318 which couples first interface 316 to a second interface 320. In some examples, one or more additional processor(s) 315, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 316. In some examples, second interface 320 may be a low pin count (LPC) interface. Various devices may be coupled to second interface 320 including, for example, a keyboard and/or mouse 322, communication devices 327 and storage circuitry 328. Storage circuitry 328 may be one or more non-transitory machine-readable storage media as described below, such as a disk drive or other mass storage device which may include instructions/code and data 330 and may implement the storage ‘ISAB03 in some examples. Further, an audio I/O 324 may be coupled to second interface 320. Note that other architectures than the point-to-point architecture described above are possible. For example, instead of the point-to-point architecture, a system such as multiprocessor system 300 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

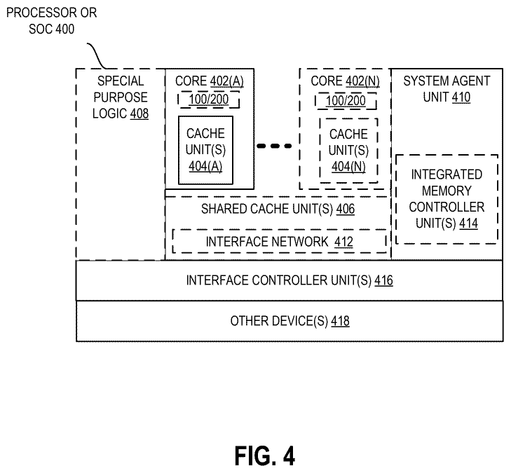

FIG. 4 illustrates a block diagram of an example processor and/or SoC 400 that may have one or more cores and an integrated memory controller. The solid lined boxes illustrate a processor 400 with a single core 402(A), system agent unit circuitry 410, and a set of one or more interface controller unit(s) circuitry 416, while the optional addition of the dashed lined boxes illustrates an alternative processor 400 with multiple cores 402(A)-(N), a set of one or more integrated memory controller unit(s) circuitry 414 in the system agent unit circuitry 410, and special purpose logic 408, as well as a set of one or more interface controller units circuitry 416. Note that the processor 400 may be one of the processors 370 or 380, or co-processor 338 or 315 of FIG. 3.

Thus, different implementations of the processor 400 may include: 1) a CPU with the special purpose logic 408 being integrated graphics and/or scientific (throughput) logic (which may include one or more cores, not shown), and the cores 402(A)-(N) being one or more general purpose cores (e.g., general purpose in-order cores, general purpose out-of-order cores, or a combination of the two); 2) a coprocessor with the cores 402(A)-(N) being a large number of special purpose cores intended primarily for graphics and/or scientific (throughput); and 3) a coprocessor with the cores 402(A)-(N) being a large number of general purpose in-order cores. Thus, the processor 400 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 400 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 404(A)-(N) within the cores 402(A)-(N), a set of one or more shared cache unit(s) circuitry 406, and external memory (not shown) coupled to the set of integrated memory controller unit(s) circuitry 414. The set of one or more shared cache unit(s) circuitry 406 may include one or more mid-level caches, such as level 2 (L2), level 3(L3), level 4(L4), or other levels of cache, such as a last level cache (LLC), and/or combinations thereof. While in some examples interface network circuitry 412 (e.g., a ring interconnect) interfaces the special purpose logic 408 (e.g., integrated graphics logic), the set of shared cache unit(s) circuitry 406, and the system agent unit circuitry 410, alternative examples use any number of well-known techniques for interfacing such units. In some examples, coherency is maintained between one or more of the shared cache unit(s) circuitry 406 and cores 402(A)-(N). In some examples, interface controller units circuitry 416 couple the cores 402 to one or more other devices 418 such as one or more I/O devices, storage, one or more communication devices (e.g., wireless networking, wired networking, etc.), etc.

In some examples, one or more of the cores 402(A)-(N) are capable of multi-threading. The system agent unit circuitry 410 includes those components coordinating and operating cores 402(A)-(N). The system agent unit circuitry 410 may include, for example, power control unit (PCU) circuitry and/or display unit circuitry (not shown). The PCU may be or may include logic and components needed for regulating the power state of the cores 402(A)-(N) and/or the special purpose logic 408 (e.g., integrated graphics logic). The display unit circuitry is for driving one or more externally connected displays.

The cores 402(A)-(N) may be homogenous in terms of instruction set architecture (ISA). Alternatively, the cores 402(A)-(N) may be heterogeneous in terms of ISA; that is, a subset of the cores 402(A)-(N) may be capable of executing an ISA, while other cores may be capable of executing only a subset of that ISA or another ISA.

### Example Core Architectures-in-Order and Out-of-Order Core Block Diagram

FIG. 5(A) is a block diagram illustrating both an example in-order pipeline and an example register renaming, out-of-order issue/execution pipeline according to examples. FIG. 5(B) is a block diagram illustrating both an example in-order architecture core and an example register renaming, out-of-order issue/execution architecture core to be included in a processor according to examples. The solid lined boxes in FIG. 5(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 5(A), a processor pipeline 500 includes a fetch stage 502, an optional length decoding stage 504, a decode stage 506, an optional allocation (Alloc) stage 508, an optional renaming stage 510, a schedule (also known as a dispatch or issue) stage 512, an optional register read/memory read stage 514, an execute stage 516, a write back/memory write stage 518, an optional exception handling stage 522, and an optional commit stage 524. One or more operations can be performed in each of these processor pipeline stages. For example, during the fetch stage 502, one or more instructions are fetched from instruction memory, and during the decode stage 506, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 506 and the register read/memory read stage 514 may be combined into one pipeline stage. In one example, during the execute stage 516, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 5(B) may implement the pipeline 500 as follows: 1) the instruction fetch circuitry 538 performs the fetch and length decoding stages 502 and 504; 2) the decode circuitry 540 performs the decode stage 506; 3) the rename/allocator unit circuitry 552 performs the allocation stage 508 and renaming stage 510; 4) the scheduler(s) circuitry 556 performs the schedule stage 512; 5) the physical register file(s) circuitry 558 and the memory unit circuitry 570 perform the register read/memory read stage 514; the execution cluster(s) 560 perform the execute stage 516; 6) the memory unit circuitry 570 and the physical register file(s) circuitry 558 perform the write back/memory write stage 518; 7) various circuitry may be involved in the exception handling stage 522; and 8) the retirement unit circuitry 554 and the physical register file(s) circuitry 558 perform the commit stage 524.

FIG. 5(B) shows a processor core 590 including front-end unit circuitry 530 coupled to execution engine unit circuitry 550, and both are coupled to memory unit circuitry 570. The core 590 may be a reduced instruction set architecture computing (RISC) core, a complex instruction set architecture computing (CISC) core, a very long instruction word (VLIW) core, or a hybrid or alternative core type. As yet another option, the core 590 may be a special-purpose core, such as, for example, a network or communication core, compression engine, coprocessor core, general purpose computing graphics processing unit (GPGPU) core, graphics core, or the like.

The front-end unit circuitry 530 may include branch prediction circuitry 532 coupled to instruction cache circuitry 534, which is coupled to an instruction translation lookaside buffer (TLB) 536, which is coupled to instruction fetch circuitry 538, which is coupled to decode circuitry 540. In one example, the instruction cache circuitry 534 is included in the memory unit circuitry 570 rather than the front-end circuitry 530. The decode circuitry 540 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 540 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 540 may be implemented using various different mechanisms. Examples of suitable mechanisms include, but are not limited to, look-up tables, hardware implementations, programmable logic arrays (PLAs), microcode read only memories (ROMs), etc. In one example, the core 590 includes a microcode ROM (not shown) or other medium that stores microcode for certain macroinstructions (e.g., in decode circuitry 540 or otherwise within the front-end circuitry 530). In one example, the decode circuitry 540 includes a micro-operation (micro-op) or operation cache (not shown) to hold/cache decoded operations, micro-tags, or micro-operations generated during the decode or other stages of the processor pipeline 500. The decode circuitry 540 may be coupled to rename/allocator unit circuitry 552 in the execution engine circuitry 550.

The execution engine circuitry 550 includes the rename/allocator unit circuitry 552 coupled to retirement unit circuitry 554 and a set of one or more scheduler(s) circuitry 556. The scheduler(s) circuitry 556 represents any number of different schedulers, including reservations stations, central instruction window, etc. In some examples, the scheduler(s) circuitry 556 can include arithmetic logic unit (ALU) scheduler/scheduling circuitry, ALU queues, address generation unit (AGU) scheduler/scheduling circuitry, AGU queues, etc. The scheduler(s) circuitry 556 is coupled to the physical register file(s) circuitry 558. Each of the physical register file(s) circuitry 558 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 558 includes vector registers unit circuitry, writemask registers unit circuitry, and scalar register unit circuitry. These register units may provide architectural vector registers, vector mask registers, general-purpose registers, etc. The physical register file(s) circuitry 558 is coupled to the retirement unit circuitry 554 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 554 and the physical register file(s) circuitry 558 are coupled to the execution cluster(s) 560. The execution cluster(s) 560 includes a set of one or more execution unit(s) circuitry 562 and a set of one or more memory access circuitry 564. The execution unit(s) circuitry 562 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 556, physical register file(s) circuitry 558, and execution cluster(s) 560 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster - and in the case of a separate memory access pipeline, certain examples are implemented in which only the execution cluster of this pipeline has the memory access unit(s) circuitry 564). It should also be understood that where separate pipelines are used, one or more of these pipelines may be out-of-order issue/execution and the rest in-order.

In some examples, the execution engine unit circuitry 550 may perform load store unit (LSU) address/data pipelining to an Advanced Microcontroller Bus (AMB) interface (not shown), and address phase and writeback, data phase load, store, and branches.

The set of memory access circuitry 564 is coupled to the memory unit circuitry 570, which includes data TLB circuitry 572 coupled to data cache circuitry 574 coupled to level 2 (L2) cache circuitry 576. In one example, the memory access circuitry 564 may include load unit circuitry, store address unit circuitry, and store data unit circuitry, each of which is coupled to the data TLB circuitry 572 in the memory unit circuitry 570. The instruction cache circuitry 534 is further coupled to the level 2 (L2) cache circuitry 576 in the memory unit circuitry 570. In one example, the instruction cache 534 and the data cache 574 are combined into a single instruction and data cache (not shown) in L2 cache circuitry 576, level 3 (L3) cache circuitry (not shown), and/or main memory. The L2 cache circuitry 576 is coupled to one or more other levels of cache and eventually to a main memory.

The core 590 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 590 includes logic to support a packed data instruction set architecture extension (e.g., AVX1, AVX2), thereby allowing the operations used by many multimedia applications to be performed using packed data.

### Example Execution Unit(s) Circuitry

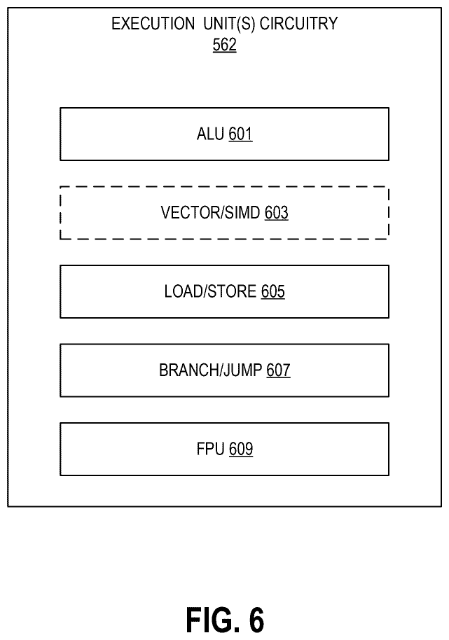

FIG. 6 illustrates examples of execution unit(s) circuitry, such as execution unit(s) circuitry 562 of FIG. 5(B). As illustrated, execution unit(s) circuity 562 may include one or more ALU circuits 601, optional vector/single instruction multiple data (SIMD) circuits 603, load/store circuits 605, branch/jump circuits 607, and/or Floating-point unit (FPU) circuits 609. ALU circuits 601 perform integer arithmetic and/or Boolean operations. Vector/SIMD circuits 603 perform vector/SIMD operations on packed data (such as SIMD/vector registers). Load/store circuits 605 execute load and store instructions to load data from memory into registers or store from registers to memory. Load/store circuits 605 may also generate addresses. Branch/jump circuits 607 cause a branch or jump to a memory address depending on the instruction. FPU circuits 609 perform floating-point arithmetic. The width of the execution unit(s) circuitry 562 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.
The following examples pertain to further embodiments. Example 1 includes a processor comprising: a Prefetch Miss Table (PMT) to store information corresponding to a history of one or more branches; and logic circuitry to cause storage of the information in the PMT based at least in part on one or more hits in an instruction cache due to one or more previous prefetch operations for the one or more branches, wherein upon a hit in the PMT, one or more prefetch requests are to be sent for the one or more branches to the instruction cache.
Example 2 includes the processor of example 1, wherein each entry of the PMT comprises a prefetch address, a confidence counter for the prefetch address. Example 3 includes the processor of example 2, wherein the confidence counter is to indicate whether a prefetch request is to be sent for the prefetch address. Example 4 includes the processor of example 1, wherein the PMT is a multi-level table having a upper table and a lower table. Example 5 includes the apparatus of example 4, wherein the upper table is to use more branch history bits than the lower table. Example 6 includes the apparatus of example 4, wherein branch history bits for each of the lower table and the upper table are to be hashed with a current linear-address instruction pointer. Example 7 includes the processor of example 1, wherein usage of the PMT is to reduce or prevent a miss in the instruction cache for a large code footprint trace.
Example 8 includes the processor of example 1, further comprising a branch history queue to store miss events. Example 9 includes the processor of example 1, comprising logic circuitry to cause storage of the information in the PMT based at least in part on one or more entries of a branch history queue. Example 10 includes the processor of example 1, wherein a System on Chip (SoC) comprises the branch prediction unit and the logic circuitry. Example 11 includes the processor of example 1, wherein the processor comprises one or more processor cores, wherein each of the one or more processor cores comprises the branch prediction unit and the logic circuitry.
Example 12 includes one or more non-transitory computer-readable media comprising one or more instructions that when executed on a processor configure the processor to perform one or more operations to cause: a Prefetch Miss Table (PMT) to store information corresponding to a history of one or more branches; and logic circuitry to cause storage of the information in the PMT based at least in part on one or more hits in an instruction cache due to one or more previous prefetch operations for the one or more branches, wherein upon a hit in the PMT, one or more prefetch requests are to be sent for the one or more branches to the instruction cache.
Example 13 includes the one or more non-transitory computer-readable media of example 12, wherein each entry of the PMT comprises a prefetch address, a confidence counter for the prefetch address. Example 14 includes the one or more non-transitory computer-readable media of example 13, wherein the confidence counter is to indicate whether a prefetch request is to be sent for the prefetch address. Example 15 includes the one or more non-transitory computer-readable media of example 12, wherein the PMT is a multi-level table having a upper table and a lower table. Example 16 includes the one or more non-transitory computer-readable media of example 15, further comprising one or more instructions that when executed on the processor configure the processor to perform one or more operations to cause the upper table to use more branch history bits than the lower table.
Example 17 includes the one or more non-transitory computer-readable media of example 15, further comprising one or more instructions that when executed on the processor configure the processor to perform one or more operations to cause branch history bits for each of the lower table and the upper table to be hashed with a current linear-address instruction pointer. Example 18 includes the one or more non-transitory computer-readable media of example 15, wherein usage of the PMT is to reduce or prevent a miss in the instruction cache for a large code footprint trace. Example 19 includes the one or more non-transitory computer-readable media of example 12, further comprising one or more instructions that when executed on the processor configure the processor to perform one or more operations to cause a branch history queue to store miss events. Example 20 includes the one or more non-transitory computer-readable media of example 12, further comprising one or more instructions that when executed on the processor configure the processor to perform one or more operations to cause logic circuitry to cause storage of the information in the PMT based at least in part on one or more entries of a branch history queue.
Example 21 includes an apparatus comprising means to perform a method as set forth in any preceding example. Example 22 includes machine-readable storage including machine-readable instructions, when executed, to implement a method or realize an apparatus as set forth in any preceding example.

In various embodiments, one or more operations discussed with reference to FIG. 1 et seq. may be performed by one or more components (interchangeably referred to herein as “logic”) discussed with reference to any of the figures.

In some embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. A processor comprising:
a Prefetch Miss Table (PMT) to store information corresponding to a history of one or more branches; and
logic circuitry to cause storage of the information in the PMT based at least in part on one or more hits in an instruction cache due to one or more previous prefetch operations for the one or more branches,
wherein upon a hit in the PMT, one or more prefetch requests are to be sent for the one or more branches to the instruction cache.

2. The processor of claim 1, wherein each entry of the PMT comprises a prefetch address, a confidence counter for the prefetch address.

3. The processor of claim 2, wherein the confidence counter is to indicate whether a prefetch request is to be sent for the prefetch address.

4. The processor of claim 1, wherein the PMT is a multi-level table having a upper table and a lower table.

5. The apparatus of claim 4, wherein the upper table is to use more branch history bits than the lower table.

6. The apparatus of claim 4, wherein branch history bits for each of the lower table and the upper table are to be hashed with a current linear-address instruction pointer.

7. The processor of claim 1, wherein usage of the PMT is to reduce or prevent a miss in the instruction cache for a large code footprint trace.

8. The processor of claim 1, further comprising a branch history queue to store miss events.

9. The processor of claim 1, comprising logic circuitry to cause storage of the information in the PMT based at least in part on one or more entries of a branch history queue.

10. The processor of claim 1, wherein a System on Chip (SoC) comprises the branch prediction unit and the logic circuitry.

11. The processor of claim 1, wherein the processor comprises one or more processor cores, wherein each of the one or more processor cores comprises the branch prediction unit and the logic circuitry.

12. One or more non-transitory computer-readable media comprising one or more instructions that when executed on a processor configure the processor to perform one or more operations to cause:
a Prefetch Miss Table (PMT) to store information corresponding to a history of one or more branches; and
logic circuitry to cause storage of the information in the PMT based at least in part on one or more hits in an instruction cache due to one or more previous prefetch operations for the one or more branches,
wherein upon a hit in the PMT, one or more prefetch requests are to be sent for the one or more branches to the instruction cache.

13. The one or more non-transitory computer-readable media of claim 12, wherein each entry of the PMT comprises a prefetch address, a confidence counter for the prefetch address.

14. The one or more non-transitory computer-readable media of claim 13, wherein the confidence counter is to indicate whether a prefetch request is to be sent for the prefetch address.

15. The one or more non-transitory computer-readable media of claim 12, wherein the PMT is a multi-level table having a upper table and a lower table.

16. The one or more non-transitory computer-readable media of claim 15, further comprising one or more instructions that when executed on the processor configure the processor to perform one or more operations to cause the upper table to use more branch history bits than the lower table.

17. The one or more non-transitory computer-readable media of claim 15, further comprising one or more instructions that when executed on the processor configure the processor to perform one or more operations to cause branch history bits for each of the lower table and the upper table to be hashed with a current linear-address instruction pointer.

18. The one or more non-transitory computer-readable media of claim 15, wherein usage of the PMT is to reduce or prevent a miss in the instruction cache for a large code footprint trace.

19. The one or more non-transitory computer-readable media of claim 12, further comprising one or more instructions that when executed on the processor configure the processor to perform one or more operations to cause a branch history queue to store miss events.

20. The one or more non-transitory computer-readable media of claim 12, further comprising one or more instructions that when executed on the processor configure the processor to perform one or more operations to cause logic circuitry to cause storage of the information in the PMT based at least in part on one or more entries of a branch history queue.
